(19) United States
(12) Patent Application Publication
(10) Pub. No.: US 2008/0302311 A1
(43) Pub. Date: Dec. 11, 2008

(54) Approach for securing an animal

(76) Inventor: Ted Blocker, Estacada, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/811,168

(22) Filed: Jun. 7, 2007

(51) Int. Cl. A01K 1/06

(52) U.S. Cl. 119/769

(57) ABSTRACT

In one embodiment, a securing device configured to be coupled to an object to facilitate the securing of an animal to the object with a lead line is provided. The securing device comprises a frame for receiving a mounting structure for coupling the frame to the object, a retaining member having a first end moveably coupled to the frame, and a magnet configured to attract a second end of the retaining member toward the frame, wherein the retaining member and frame are configured to accept a length of the lead line in an interlaced fashion to frictionally retain the lead line.

### BACKGROUND

Users of saddle and pack animals, such as horses, donkeys, llamas, camels, etc., may at times leave an animal unattended. To prevent the animal from wandering away, the user may tie or otherwise secure the animal to a fixed object with a lead line or rope.

In places where saddle or pack animals are frequently left unattended, various devices to which the animals may be tied are sometimes provided. One common example of such a device is a hitching post. A hitching post typically includes a horizontal bar to which the animals may be tied, and one or more vertical supports that support and raise the horizontal bar off of the ground. Another common device to which an animal may be tied is a tie ring. A tie ring includes a ring to which a lead line may be tied, and some mechanism (for example, an eyebolt) for securing the ring to a post or other fixed object.

While known securing devices may be relatively simple to use and construct, they also have various drawbacks. For example, if an animal tied to a hitching post or tie ring pulls on the lead line excessively, the knot securing the horse to the tie ring may pull tight, making it difficult to untie the animal. Also, it may be difficult for beginning riders to learn how to tie the animal to these devices.

Furthermore, securing an animal to a fixed object with a knot may present various dangers. For example, if an animal is frightened or startled, the animal may pull back against the knot. If the knot used to tie the animal does not have any give, the animal may feel trapped. This may cause the animal to panic and pull harder against the knot. If the animal continues to panic, it may injure itself or it may present a danger to anybody that attempts to untie it. This may be an especially dangerous situation if the animal is tied into a transport trailer, due to the confined nature of such trailers.

The use of an ordinary tie ring aboard a transport trailer may also present a serious danger when an animal falls down inside of the trailer. If the knot used to tie the animal into the trailer has no give, the animal's head may be twisted into an unnatural or harmful position by the tension of the lead rope when the animal falls. This may cause serious injury to the animal, and may also prevent the animal from reorienting its head and/or body into a position from which it can right itself. Furthermore, this may cause the animal to panic, and thus to present a danger to itself and anyone who enters the trailer to try to help the animal.

Various solutions to these problems have been proposed. For example, one solution involves tying the animal to an elastic device, for example an automobile inner tube, which is fixed to an object such as a wall, a tree, etc. If a panicked animal pulls against the inner tube, the inner tube may stretch, which may prevent the animal from injuring itself. However, because the elastic member exerts a continuous force against the animal when the animal pulls against it, the animal may still experience the feeling that it is trapped, and may become panicked. Also, the continuous pull may cause the animal to tend to fight against the elastic member. This may tend to reinforce any pull back problems the animal may have

Another known solution involves the use of a breakaway device that releases when an animal pulls against the device with enough force. While breakaway devices can allow a panicked animal to free itself, the sudden nature of the release may cause the lead line to snap back toward the animal with enough force to injure the animal. Furthermore, the animal may fall down or into surrounding objects due to the sudden release of the lead line, which may cause injury to the animal. Finally, the release of the lead line may leave the animal completely unsecured to any fixed object, and thus free to wander off.

Yet another solution involves the use of a quick release device. These quick release devices must be manually released by a human. Where an animal has fallen over or is panicked, it can be dangerous for a human to approach the animal to manually release the device. Thus, the quick release device can suffer from similar issues as if the animal were secured without the quick release device due to the need for direct human intervention.

The inventor of the present disclosure in recognizing the above issues has provided an approach disclosed in U.S. Pat. Nos. 6,684,613 and 7,111,588. These patents disclose a securing device comprising, a frame, and a retaining member disposed between opposing sides of the frame. The retaining member and frame can accept a length of the lead line in an interlaced fashion to frictionally retain the lead line. In this manner, a panicked animal may pull a length of rope through the device, thereby alleviating the animal's panic while keeping the animal secured to the device.

### SUMMARY

As one embodiment of the present disclosure, a securing device is provided which is configured to be coupled to an object to facilitate the securing of an animal to the object with a lead line. This embodiment comprises a frame for receiving a mounting structure for coupling the frame to the object, said frame including opposing sides, a retaining member having a first end moveably coupled to the frame, and a magnet configured to attract a second end of the retaining member toward the frame, wherein the retaining member and frame are configured to accept a length of the lead line in an interlaced fashion to frictionally retain the lead line.

As another embodiment of the present disclosure, a securing device is provided which is configured to be coupled to an object to facilitate the securing of an animal to the object with a lead line. This embodiment comprises a frame comprising a rigid core material at least partially covered by a coating, and a retaining member coupled to the frame, wherein the retaining member and frame are configured to accept a length of the lead line in an interlaced fashion to frictionally retain the lead line.

Additionally, a method of securing an animal to a fixed object with a securing device via a lead line coupled to the animal is provided. The securing device comprises a frame having an opening and a retaining member having a first end pivotally coupled to the frame, a second end, and a magnet configured to attract the second end to the frame. The method comprises rotating the second end of the retaining member away from the frame with a force sufficient to overcome the magnetic attraction between the second end of the retaining member and the frame, inserting a portion of the lead line through the opening of the frame, and rotating the second end of the retaining member toward the frame to a proximity sufficient for the magnet to attract the second end of the retaining member to the frame, thereby interlacing the lead line with the frame and retaining member.

### BRIEF DESCRIPTION OF THE DRAWINGS

FIG. 1 is a perspective view of a first embodiment of a securing system according to the present invention, with a horse secured to the system.

FIG. 2A is an isometric view of a first side of the embodiment of FIG. 1.

FIG. 2B is an isometric view of a second side of the embodiment of FIG. 1.

FIG. 2C is an isometric view of the second side of the embodiment of FIG. 1 illustrating alternative positions of the retaining member.

FIG. 2D is an isometric view of another embodiment of a securing system including a torsion spring.

FIG. 3 is an isometric view of the embodiment of FIG. 1, with a loop of a lead line inserted partially through the securing system.

FIG. 4 is an isometric view of the embodiment of FIG. 1, with a loop of lead line secured in the system.

FIG. 5 is a perspective view of the embodiment of FIG. 1, mounted to a picket line.

FIG. 6 is a side view of another embodiment of a securing system.

FIG. 7 is a front view of the embodiment of FIG. 6.

FIG. 8 is a side view of another embodiment of a securing system.

FIG. 9 is a front view of the embodiment of FIG. 8.

FIG. 10 is a sectional view of an embodiment of a securing system comprising an outer coating.

FIG. 11 is a view of an embodiment of a securing system comprising raised members to prevent sliding of the retaining member along the frame.

FIG. 12 is a view of another embodiment of a securing system comprising a recessed segment of the frame in which the retaining member is nested to prevent sliding of the retaining member along the frame.

FIG. 13 is an isometric view of another embodiment of a securing system including an integrated mounting structure.

### DETAILED DESCRIPTION OF THE PREFERRED EMBODIMENTS

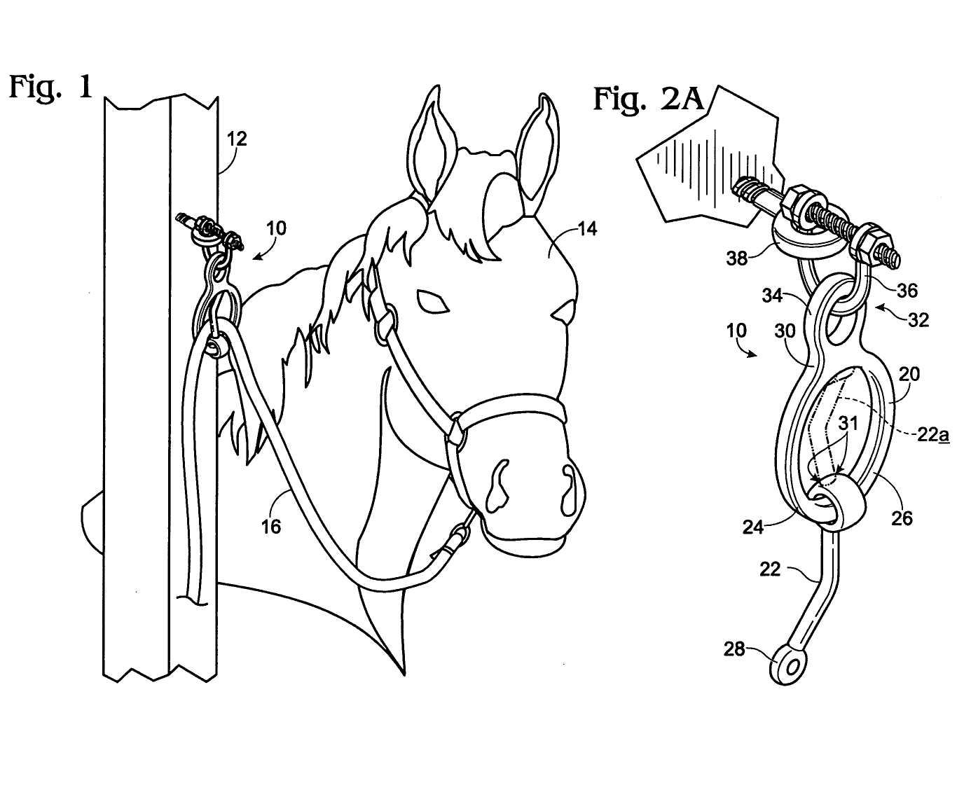

A first embodiment of a system for securing an animal is shown at 10 in FIG. 1. As depicted, securing system 10 is mounted to a post 12, and is used to secure a horse 14 to the post with a rope or other suitable lead line 16. However, it will be appreciated that securing system 10 may be used to secure any desired type of animal, and may be mounted to any other suitable surface or object, such as a tree, a wall, an inside surface of a trailer, or on a picket line, as described in more detail below.

Securing system 10 is configured to frictionally retain a lead line, without a knot to fix the lead line to the securing system. However, it should be appreciated that, in some examples, securing system 10 may be used with a knot to further securing the lead line. Generally, a securing system according to the present disclosure comprises a plurality of spaced-apart members configured to accept a length of lead line in an interwoven or interlaced fashion. When the lead line is pulled, such as by the animal, the friction exerted against the sides of the lead line by the spaced-apart members causes the lead line to resist being pulled through the securing system.

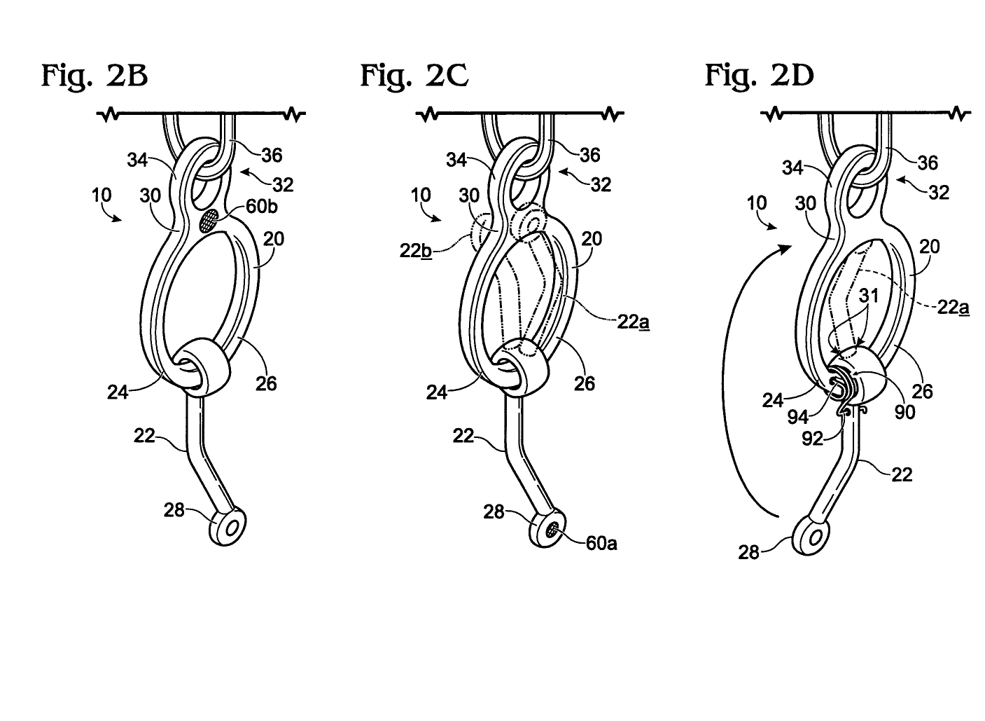

The plurality of spaced-apart members may be arranged in any suitable manner. For example, the plurality of spaced-apart members may be arranged parallel to one another, in a comb-shaped array. In the depicted embodiment, securing system 10 includes a frame 20, and a retaining member 22 coupled with the frame. The structure of securing system 10 is shown in more detail in FIG. 2A. The spaced-apart members correspond to a first side 24 of frame 20, a second side 26 of the frame, and retaining member 22. Securing system 10 is configured to have lead line 16 coupled in such a manner that it is woven behind retaining member 22 and in front of first side 24 and second side 26 of frame 20. Each point of contact of lead line 16 with first and second sides 24, 26 of frame 20 and with retaining member 22 contributes to the frictional retention of the lead line by securing system 10.

Ordinarily, securing system 10 exerts a sufficiently strong frictional force on lead line 16 for an animal to perceive that it is tied to object 12. However, the frictional force may be overcome with a sufficiently strong pull, allowing an animal secured to securing system 10 to pull a length of lead line through the securing system should the need arise. For example, if an animal secured to a securing system 10 inside of a trailer falls down, lead line 16 may be pulled through securing system 10 sufficiently to prevent the animal from hanging itself or to reduce the severity of any injury that may otherwise occur. Also, the animal may be able to pull a sufficient length of lead line 16 through securing system 10 to get its head and/or body into a position from which it can right itself.

Likewise, if a startled or panicked animal pulls against securing system 10, it may be able to pull a sufficient amount of lead line 16 through the securing system to realize that it is not trapped. This may help calm the animal, and also may allow the animal to pull back sufficiently to assess the situation, further helping to prevent panic. Furthermore, unlike the use of a quick-release mechanism, the animal remains secured to securing system 10 even after pulling a length of lead line 16 through the securing system. It may be possible for a sufficiently panicked animal to pull the entire lead line, typically 8 10 feet long, through securing system 10. However, a knot may be tied in the end of lead line 16 to prevent the lead line from being pulled free of securing system 10, if desired.

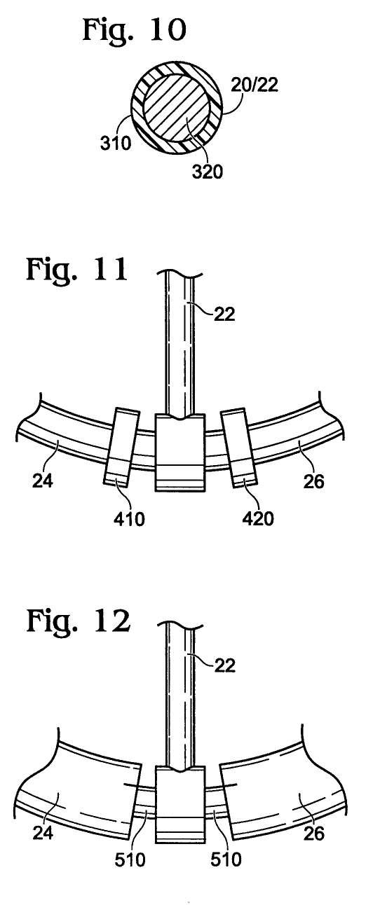

Frame 20 may have any suitable shape and construction. In the depicted embodiment, frame 20 has a generally curvilinear shape, and more specifically, a ring shape. The use of a curvilinear frame may be advantageous, as a frame of this shape may not have sharp corners or other protrusions on which a lead line may become snagged, or on which an animal may injure itself. Additionally, a ring-shaped frame may be combined with an elongate retaining member 22 to form a securing system 10 with an appearance similar to one-half of a snaffle bit, as shown in FIG. 2A. This appearance may be familiar or pleasing to owners or users of riding and/or pack animals. Frame 20 may be constructed from one or more different materials as will be described in greater detail with reference to FIG. 10.

Likewise, retaining member 22 may have any suitable configuration. Generally, retaining member 22 is configured to retain a loop of lead line 16 that is looped around the retaining member, and to cause friction against the lead line when the lead line is pulled. In the embodiment shown in FIG. 2A, retaining member 22 has an elongate configuration, and is pivotally attached to frame 20 such that it is pivotal between an open position, shown in solid lines at 22, and at least one closed position, shown in dashed lines at 22a, for example. When in the closed position, the free end 28 of the retaining member rests against a top portion 30 of frame 20. This prevents lead line 16 from becoming accidentally disengaged from securing system 10 by slipping over the top of retaining member 22. Free end 28 of retaining member 22 may include an expanded portion, such as the ring-shaped portion shown in the depicted embodiment, to further help prevent lead line 16 from slipping over the top of retaining member 22.

Retaining member 22 may have either a straight shape, or may have a bent or curved shape. The use of a bent or curved retaining member 22 may be desirable for some applications. For example, a straight, bent, or curved shape may be used to force lead line 16 to move toward a desired position along the retaining member when the lead line is pulled. For example, in the depicted embodiment, retaining member 22 has a bent shape that is configured to drive lead line 16 towards the bottom of frame 20, to where retaining member 22 is coupled with frame 20, when the lead line is pulled. This may help to prevent lead line 16 from accidentally slipping over the top of retaining member 22. Furthermore, this may help to drive lead line 16 into the corners 31 formed where retaining member 22 meets frame 20, and thus may help to increase the friction exerted by securing system 10 on lead line 16. In this manner, the amount of friction exerted against lead line 16 may be varied by varying the thickness and/or the flexibility of the lead line. The use of a thinner and/or more flexible lead line 16 may result in the exertion of less friction against the lead line, while the use of a thicker and/or less flexible lead line may result in the exertion of more friction against the lead line.

In addition to frame 20 and retaining member 22, securing system 10 may also include a mounting structure coupled with the frame and the retaining member for mounting the securing system 10 to any suitable object. The mounting structure may have any suitable form that facilitates the mounting of securing system 10 to an object. For example, the mounting structure may take the form of an eyebolt through which frame 20 is threaded. In the depicted embodiment, however, the mounting structure, indicated generally at 32, takes the form of a mounting ring 34 coupled with frame 20. Ring 34 is configured to accept the attachment of a coupling device, such as a U-bolt 36. In turn, U-bolt 36 may then be coupled to another fastener, such as eyebolt 38, which is fastened to a selected object. As yet another example, a carabiner may be used to couple the frame and retaining member to the mounting structure, for example, as illustrated by FIG. 13. If a more permanent attachment of securing system 10 to the object is desired, eyebolt 38 may be attached directly to mounting ring 34, without the use of U-bolt 36 or other suitable intermediate coupling. However, this may increase the difficulty of moving securing system 10 between different locations. Also, while mounting ring 34 is depicted as having a generally circular shape, it will be appreciated that the mounting ring may have any other suitable shape, such as a polygonal, rectangular, or oval shape. Furthermore, while mounting ring 34 is depicted as being integral with frame 20, it will be appreciated that the mounting ring may also be formed as a separate part that is welded, bolted, riveted, adhered to, or otherwise coupled to frame 20, and that any suitable structure other than mounting ring 34 may be used to mount frame 20 to an object.

FIGS. 2B illustrates an opposite side of securing system 10 as shown in FIG. 2A, depicting a magnet 60b provided with frame 20. Magnet 60b can be included with some or all of the embodiments described herein to increase the holding force between free end 28 of retaining member 22 and top portion 30 of frame 20. Magnet 60b may have any suitable shape and size, and may be coupled to frame 20 in any suitable manner. As one non-limiting example, magnet 60b may be set within a recess in the surface of frame 20 so that the face of the magnet resides within the same plane as the surface of the frame. In this way, magnet 60b may be configured such that it does not substantially protrude from the surface of frame 20. Alternatively, a portion of magnet 60b may partially or completely protrude from the surface of the frame, or may recessed such that the face of magnet 60b is disposed below the surface of frame 20.

In some embodiments, for example, as shown in FIG. 2C, free end 28 may include a magnet 60a. Magnet 60a can be included with free end 28 to increase the holding force between retaining member 22 and top portion 30 when the retaining member is rotated to the position indicated by 22a or 22b. Magnet 60a can be configured to have a magnet face arranged on each side of free end 28. However, in some embodiments, magnet 60a can be configured on only one side of free end 28. Where magnets 60a and 60b are used in combination, magnet 60a can be configured to include a magnet face having a polarity that is opposite the polarity of the corresponding face of magnet 60b. In this way, magnets 60a and 60b can be attracted to each other, thereby further increasing the holding force between retaining member 22 and upper portion 30 of frame 20. However, it should be appreciated that magnet 60a may be omitted in other embodiments, for example, as illustrated by FIGS. 2A, 2B, and 2D.

Magnets 60a and 60b may be formed from any suitable magnetic material. In some embodiments, including but not limited to metal, ceramic and other types of permanent magnets. Where retaining member 22 does not include magnet 60a, it may be constructed from a material that is attracted to magnet 60b, including but not limited to a metal containing nickel, iron, cobalt, etc.

Magnets 60a and/or 60b may help to hold retaining member 22 securely closed against frame 20. This may help to prevent retaining member 22 from falling opening. For example, when securing system 10 is attached to an object low to the ground, a secured animal may pull the lead line up from the corners where retaining member 22 meets frame 20. Absent magnets 60a and 60b, this may allow retaining member 22 to fall open in some situations. However, magnet 60a and/or 60b provide sufficient force to hold retaining member 22 against frame 20 even when the lead line is insufficiently tensioned or in a poor location for providing this force. Likewise, magnets 60a and/or 60b may help to hold retaining member 22 in a securely closed position when not in use. This may help to reduce noise caused by the rattling of a securing device 20 in an animal trailer.

FIG. 2C further illustrates how retaining member 22 may be rotated relative to the frame so that free end 28 contacts top portion 30 in at least two positions. For example, a first position 22a, as also illustrated in FIG. 2A, may be selected by the user to provide a first level of holding force between rotating member 22 and a first side of top portion 30. Alternatively, the user may select a second position indicated at 22b to avoid the magnetic holding force of the first position 22a. In this manner, the user may vary the holding force provided to the lead line for securing an animal by selecting one of the two positions illustrated in FIG. 2C.

The difference in the level of holding force between the first position 22a and the second position 22b may be due to the inclusion of magnet 60b (e.g. as shown in FIG. 2B) on the first side of the frame for receiving the retaining member as indicated at 22a, but not on the second opposite side for receiving the retaining member as indicated at 22b. Similarly, the difference in the level of holding force between the first position 22a and the second position 22b may be due to the inclusion of magnet 60a (e.g. as shown in FIG. 2C) on only one side of free end 28. Alternatively, each side of the frame 20 and/or free end of retaining member 22 may include a magnet, whereby different levels of holding force are provided by the inclusion of magnets of different strengths. In this way, magnetic force may be used to increasing the holding force between the retaining member and the frame. Note that the various approaches described herein may be utilized with retaining members having any suitable shape, including bent (e.g. as illustrated in FIGS. 2A-2C), curved, or straight.

In other embodiments, holding force between retaining member 22 and top portion 30 of the frame may be increased by a spring force. FIG. 2D illustrates securing system 10 including a torsion spring 90 for transmitting a rotational spring force between frame 20 and retaining member 22. As one example, torsion spring may be configured so that the retaining member is held against upper portion 30, whereby the holding force is increased as free end 28 of retaining member 22 is rotated away from the position indicated at 22a. Torsion spring 90 is shown external retaining member 22 in FIG. 2D for clarity of presentation, however torsion spring 90 may be housed at least partially within or entirely within retaining member 22 and/or frame 20. In this way, securing system 10 may be free of surface protrusions caused by the inclusion of torsion spring 90.

Torsion spring 90 may include a first end 92 coupled to retaining member 22 and a second end 94 coupled to frame 20. As free end 28 of retaining member 22 is rotated away from position 22a, spring 90 may be stretched or compressed from its equilibrium position to provide an increase in spring force between retaining member 22 and frame 20. In this way, retaining member 22 may be returned to position 22a without necessarily requiring input from the user. While a torsion spring is described for increasing the holding force between retaining member 22 and frame 20, it should be appreciated that other suitable types of springs may be used to provide a spring force. It will be appreciated that spring may be used in combination with magnet 60b and/or magnet 60a, or may be used alone, to provide any desired amount of force for holding retaining member 22 against frame 20.

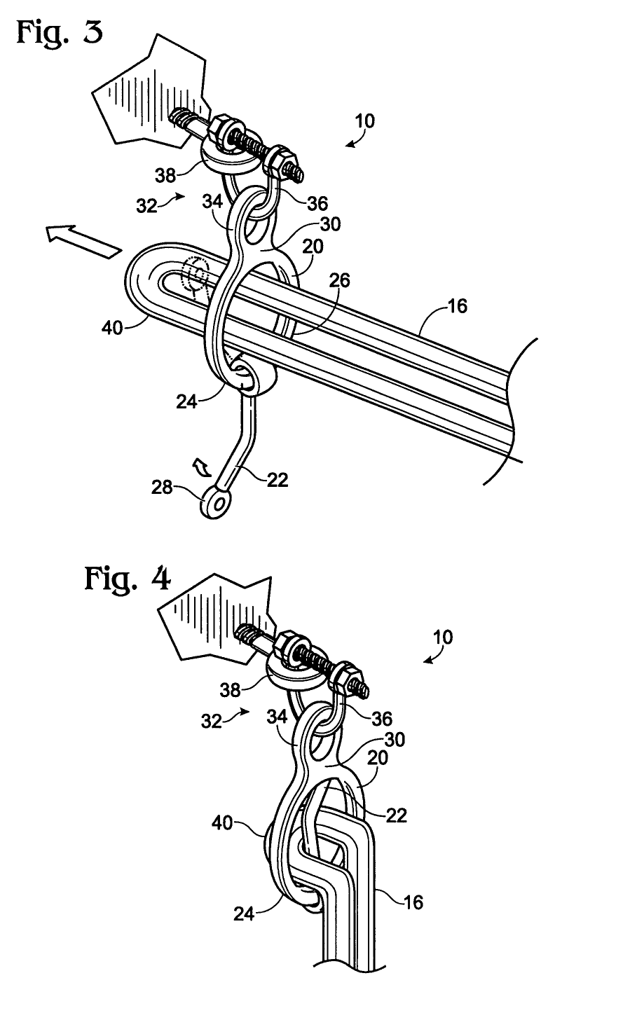

Securing system 10 offers the advantage over known tie rings and hitching posts that lead line 16 may be coupled to the securing system without the use of knots. The coupling of lead line 16 to securing system 10 is shown in more detail in FIGS. 3 and 4. Referring to FIG. 3, a loop 40 of lead line 16 is first inserted through the opening defined by frame 20. Next, retaining member 22 is moved from the opened position to the closed position and through loop 40 so that the loop extends around the retaining member. Note that retaining member may be moved to one of two closed positions, for example, as illustrated at 22a and 22b of FIG. 2C. Referring next to FIG. 4, lead line 16 is secured by pulling loop 40 downwardly against retaining member 22 and sides 24 and 26 of frame 20. Lead line 16 may be removed from securing system 10 by pushing retaining member 22 back from frame 20 and then pulling loop 40 back through frame 20.

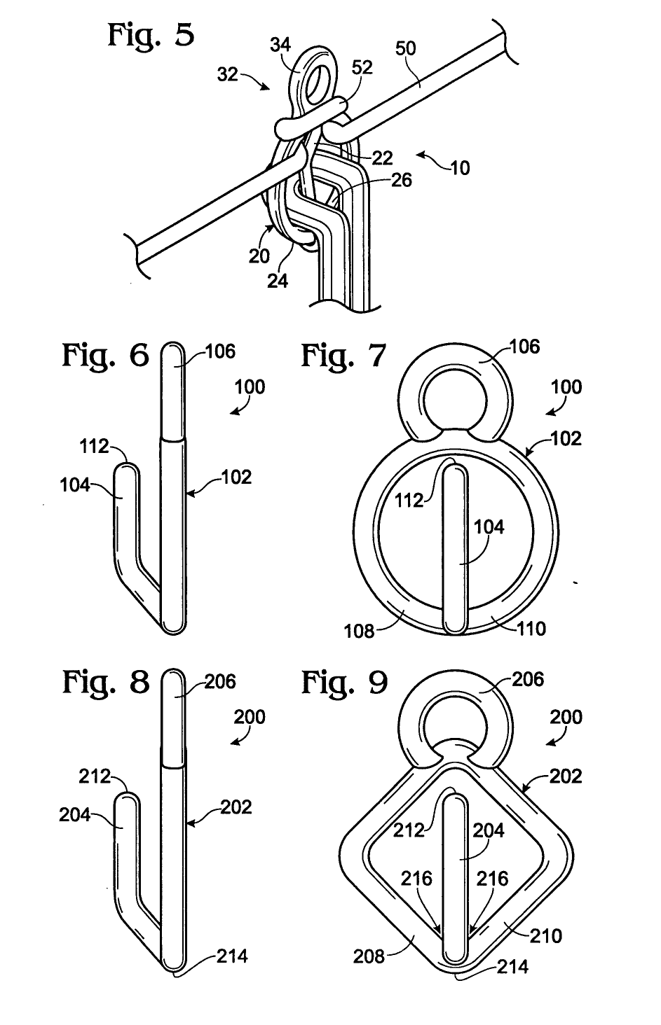

FIG. 5 shows the use of securing system 10 on a picket line 50. A picket line is a line stretched between two (or more) objects to which animals may be attached. Ordinarily, an animal is attached to a picket line by tying the animal to a steel ring that is tied into the picket line. However, tying the animal to the picket line presents a danger of the animal becoming entangled either in the tie line or the picket line, as well as the danger of a panicked animal feeling trapped.

Securing system 10 may be used in the place of an ordinary steel ring on a picket line to allow an animal to be more safely secured to a picket line. As shown in FIG. 5, securing system 10 may be attached to picket line 50 simply by pulling a loop 52 of the picket line through frame 20 and then over mounting ring 34. Once securing system 10 is attached to picket line 50, a lead line may be attached to the securing system via the methods described above.

FIGS. 6 and 7 show, generally at 100, a second embodiment of a securing system according to the present invention. Securing system 100 is similar in many respects to securing system 10 of FIGS. 1 through 5. For example, securing system 100 includes a frame 102, a retaining member 104 and a mounting structure 106. Frame 102 includes a first side 108 and a second side 110, which, together with retaining member 104, form a plurality of spaced-apart members around which a lead line may be interwoven or interlaced to frictionally secure the lead line to the securing system.

However, unlike retaining member 22 of securing system 10, retaining member 104 of securing system 100 is fixed to frame 102, and does not pivot between open and closed positions with respect to the frame. Instead, to allow a loop of lead line to be extended around the retaining member, retaining member 104 has a free end 112 over which the loop of lead line may be placed. Retaining member 104 is typically long enough to prevent the loop of lead line from accidentally slipping over free end 112 of the retaining member.

Retaining member 104 may have any suitable shape. For example, retaining member 104 may have a bent shape, as depicted in FIGS. 6 and 7. The use of a bent or curved shape may be advantageous, as described above, as this shape tends to drive the lead line downwardly toward the bottom of the retaining member when pulled. Alternatively, retaining member 104 may have a straight configuration, and may extend either fully within the space defined by frame 102 or outwardly from this space.

FIGS. 8 and 9 show, generally at 200, a third embodiment of a securing system according to the present invention. Securing system 200 is similar in many respects to securing system 100 of FIGS. 6 and 7. For example, securing system 200 includes a frame 202, a retaining member 204 and a mounting structure 206. Additionally, frame 202 includes a first side 208 and a second side 210, which, together with retaining member 204, form a plurality of spaced-apart members around which a lead line may be interwoven or interlaced to frictionally secure the lead line to the securing system. Furthermore, retaining member 204 is fixed to frame 202, and has a free end 212 over which a loop of a lead line may be placed to attach the lead line to securing system 200.

However, unlike frame 102 of securing system 100, frame 202 of securing system 200 has a polygonal shape, rather than a circular or oval shape. The use of a polygonal frame may offer some advantages over other shapes. For example, if retaining member 204 is coupled with frame 202 at a corner 214 of polygonal frame 202 (as shown in the depicted embodiment), the interior corners 216 where the retaining member meets the frame may be tighter than the corresponding interior corners of a round frame of a similar size, and thus may cause a greater frictional force on a lead line that is pulled into corners 216.

While securing system 200 has a rectangular frame, it will be appreciated that a frame of any other suitable polygonal or ovular shape may be used without departing from the scope of the present invention. Furthermore, while retaining member 204 is shown as being fixed to frame 200, retaining member 204 may also be pivotally coupled, or otherwise movably coupled, to frame 200, and magnetic and/or spring force may be used to hold retaining member 204 closed against frame 200, as described above.

FIG. 10 shows a sectional view of a structural component, either frame 20 or retaining member 22, of a securing device. The structural component comprises a core 320 and a skin or coating 310. Core 320 and coating 310 may be constructed from different materials such that coating provides protective and noise-reducing characteristics to a securing device. For example, where core 320 is constructed of a rigid material, such as a metal, coating 310 may be constructed from a less rigid, weather-resistant material, such as a polymer. A polymer material for coating 310 may include natural rubber, synthetic rubber, or plastic, among other suitable polymers. As an alternative example, coating 310 may be constructed from leather.

Coating 310 may be included on the outer surface of core 320 to reduce the level of noise or sound that is produced when the frame or retaining member contact each other or another object. In this way, sounds produced by the rattling of the securing system may be reduced. In some examples, the entire surface of the core of frame 20 and/or the core of retaining member 22 may be covered by coating 310. In other examples, core of frame 20 and/or the core of retaining member 22 are only partially covered by coating 310. Further, in some examples, frame 20 and/or retaining member 22 may only include the core and may completely omit the coating. Additionally, portions of the mounting structure including ring 34, U-bolt 36, and/or eyebolt 38 may include a coating as well.

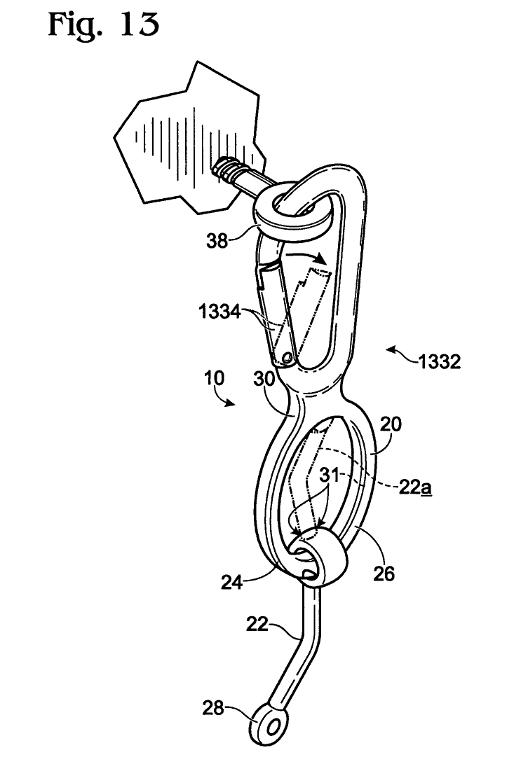

FIGS. 11 and 12 illustrate a partial view of example pivotal connections between frame 20 and retaining member 22 that may used to retain the retaining member along a defined region of frame 20, thereby preventing retaining member 22 from sliding along frame 20. For example, FIG. 11 illustrates an example where frame 20 includes a pair of stays for reducing translation of retaining member 22 relative to frame 20. The first side 24 of frame 20 includes a first stay configured as raised portion 410 for preventing retaining member 22 from sliding or translating along the frame in the direction of the first side 24. Similarly, the second side 26 includes a second stay configured as raised portion 420 for preventing retaining member 22 from sliding or translating along the frame in the direction of the second side 26. Thus, retaining member 22 is retained within a region of the frame defined by stays 410 and 420.

FIG. 12 illustrates another embodiment of structures configured to prevent retaining member 22 from sliding or translating along the frame 20. In the example illustrated by FIG. 12, the first side 24 and the second side 26 of frame 20 are joined by recessed portion 510 having a smaller diameter or different cross-section than the first side 24 and the second side 26. Retaining member 22 can include an opening for receiving recessed portion 510 that is of smaller diameter or different cross-section than the first side 24 and the second side 26. Therefore, in this embodiment, stays for holding retaining member 22 in place on frame 20 are formed by the sides of recessed portion 510. Thus, retaining member 22 may be retained within a region of the frame defined by the first side 24 and the second side 26.

Note that the examples illustrated by FIGS. 11 and 12 may be utilized with the various embodiments described herein. For example, the first embodiment described herein with reference to FIGS. 1 through 5 may include a frame having a pair of stays as illustrated by FIG. 11 or FIG. 12 to prohibit sliding or translation of retaining member 22 along the frame.

FIG. 13 is a view of another embodiment of a securing system including an integrated mounting structure. The embodiment of FIG. 13 can include components that are similar to the embodiment depicted by FIG. 2A, whereby mounting structure 32 is replaced by an integrated mounting structure 1332. Integrated mounting structure 1332 can include a gate 1334 that can be opened or closed to accept a fastener such as eyebolt 38. Thus, as one embodiment mounting structure 1332 includes a carabiner or clip integral with frame 20.

While gate 1334 is shown as a member having a similar configuration as the ring portion of the mounting structure, it should be appreciated that gate 1334 may be alternatively configured as a wire gate. In some embodiments, gate 1334 may include a spring for returning gate 1334 to the closed position. However, with wire gate configurations, the wire gate may be configured to return to the closed position as will be appreciated in light of the present disclosure. It will be appreciated that the clip or carabineer structure depicted in FIG. 13 is shown merely for the purpose of example, and that any other integrated clipping or attaching structure may be used and is within the scope of the disclosure.

The disclosure set forth above encompasses multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious and directed to one of the inventions. These claims may refer to “an” element or “a first” element or the equivalent thereof; such claims should be understood to include incorporation of one or more such elements, neither requiring nor excluding two or more such elements. Inventions embodied in other combinations and subcombinations of features, functions, elements, and/or properties may be claimed through amendment of the present claims or through presentation of new claims in this or a related application. Such claims, whether directed to a different invention or to the same invention, and whether broader, narrower, equal, or different in scope to the original claims, also are regarded as included within the subject matter of the inventions of the present disclosure.

1. A securing device configured to be coupled to an object to facilitate the securing of an animal to the object with a lead line, the device comprising:
a frame for receiving a mounting structure for coupling the frame to the object, said frame including opposing sides;
a retaining member having a first end moveably coupled to the frame; and
a magnet configured to attract a second end of the retaining member toward the frame;
wherein the retaining member and frame are configured to accept a length of the lead line in an interlaced fashion to frictionally retain the lead line.

2. The securing device of claim 1, wherein the magnet is disposed on the frame.

3. The securing device of claim 1, wherein the magnet is disposed on the second end of the retaining member and wherein at least a portion of the frame for receiving the second end is constructed from a material that is attracted by the magnet.

4. The securing device of claim 1, wherein the retaining member is pivotally coupled to the frame and wherein the magnet attracts the second end of the retaining member toward a closed position against the frame.

5. The securing device of claim 1, wherein at least a portion of an outer surface of the frame includes a protective coating.

6. The securing device of claim 1, wherein at least a portion of an outer surface of the retaining member includes a protective coating.

7. The securing device of claim 1, wherein the retaining member has a bent configuration configured to urge the lead line into a corner at which the retaining member meets the frame when the lead line is pulled.

8. A securing device configured to be coupled to an object to facilitate the securing of an animal to the object with a lead line, the device comprising:
a frame comprising a rigid core material at least partially covered by a coating; and
a retaining member coupled to the frame, wherein the retaining member and frame are configured to accept a length of the lead line in an interlaced fashion to frictionally retain the lead line.

9. The securing device of claim 8, wherein the core is constructed from a harder material than the coating.

10. The securing device of claim 8, wherein the coating is constructed from a polymer.

11. The securing device of claim 8, wherein the retaining member comprises a core at least partially surrounded by a coating.

12. The securing device of claim 8, wherein a first end of the retaining member is pivotally coupled to the frame.

13. The securing device of claim 12, wherein the frame further includes a magnet.

14. The securing device of claim 12, wherein a second end of the retaining member comprises a magnet.

15. The securing device of claim 12, wherein the frame further includes a pair of stays, and wherein the first end of the retaining member is retained between the pair of stays to reduce lateral translation of the retaining member.

16. The securing device of claim 8, wherein the retaining member has a bent configuration configured to urge the lead line into a corner at which the retaining member meets the frame when the lead line is pulled.

17. The securing device of claim 8, further comprising a torsion spring having a first end coupled to the retaining member and a second end coupled to the frame for urging a second end of the retaining member toward the frame.

18. A method of securing an animal to a fixed object with a securing device via a lead line coupled to the animal, wherein the securing device is mounted to the object and the securing device comprises a frame having an opening, a retaining member having a first end pivotally coupled to the frame and a second end, and a magnet configured to attract the retaining member to the frame, the method comprising:
rotating the second end of the retaining member away from the frame with a force sufficient to overcome the magnetic attraction between the second end of the retaining member and the frame;
inserting a portion of the lead line through the opening of the frame;
and rotating the second end of the retaining member toward the frame to a proximity sufficient for the magnet to attract the second end of the retaining member to the frame, thereby interlacing the lead line with the frame and retaining member.

19. The method of claim 18, wherein the magnet is disposed on the frame.

20. The method of claim 18, wherein the magnet is disposed on the second end of the retaining member.
